(19) United States
(12) Patent Application Publication
(10) Pub. No.: US 2025/0137851 A1
(43) Pub. Date: May 1, 2025

(54) BLUETOOTH FOOD THERMOMETER AND ASSEMBLY THEREOF

(71) Applicant: Zhican HUANG, Fujian (CN)

(72) Inventor: Zhican HUANG, Fujian (CN)

(21) Appl. No.: 18/383,911

(22) Filed: Oct. 26, 2023

(51) Int. Cl. G01K 1/024; G01K 1/08; H01Q 1/36

(52) U.S. Cl. CPC G01K 1/024; G01K 1/08; H01Q 1/36

(57) ABSTRACT

The present invention relates to a Bluetooth food thermometer and an assembly thereof, where the Bluetooth food thermometer includes a shell in which a temperature measuring component is movably arranged; a fall resisting component is arranged between the temperature measuring component and the shell; the temperature measuring component includes a copper tube antenna and a first circuit board; a first end of the copper tube antenna is connected with the first circuit board through a fastener; and a second end of the copper tube antenna is electrically contacted with the shell. In the present invention, the fall resisting component is arranged between the temperature measuring component and the shell, so that the food thermometer can protect the temperature measuring component from different directions when falling; and, during assembly, the fall resisting component can position the temperature measuring component for easy assembly.

### TECHNICAL FIELD

The present invention relates to the technical field of a food thermometer, more specifically, to a Bluetooth food thermometer and an assembly thereof.

### BACKGROUND OF THE INVENTION

In a food preparation process, temperature control is crucial to a final taste and quality. In order to achieve this, a food thermometer is usually used to measure a temperature of target ingredients accurately. Such thermometer is characterized by high accuracy, durability and legibility, meeting stringent requirements for commercial and professional uses. The design of the food thermometers takes into account different purposes and application scenarios, making use of changes in solids, liquids and gases affected by the temperature to produce a variety of thermometers. These thermometers can measure a pressure of a gas (or vapor) under a constant volume condition, and a phenomenon that resistance changes with the temperature, while also taking into account the effect of thermal radiation. In addition, the food thermometers also include thermoelectric effects, which are taken into account in the design of the thermometers to ensure accuracy and reliability thereof. These thermometers are not only suitable for the field of food processing and preparation, but can also be used in other fields where the temperature measurement is required.

However, in order to accurately detect an internal temperature of food in the process of use, a probe of the existing food thermometer is often inserted into the food, but the thermometer may fall off from the food in the process of cooking or fall out of a hand of a person during the process of taking it, especially when the person does not notice that the thermometer is not cooled, resulting in the falling off of the thermometer which causes that an internal solder joint of the thermometer is loose or the device is damaged, and that the thermometer cannot be used normally.

The above deficiencies need to be improved.

### BRIEF SUMMARY OF THE INVENTION

In order to solve the problem that the existing food thermometer is easy to fall and cause a damage to an internal part, the present invention provides a Bluetooth food thermometer and an assembly thereof.

A technical solution of the present invention is described as follows:

A Bluetooth food thermometer, wherein the Bluetooth food thermometer comprises a shell in which a temperature measuring component is movably arranged;

a fall resisting component is arranged between the temperature measuring component and the shell; the fall resisting component is used to protect the temperature measuring component when falling; the temperature measuring component comprises a copper tube antenna and a first circuit board; a first end of the copper tube antenna is connected with the first circuit board through a fastener; and a second end of the copper tube antenna is electrically contacted with the shell.

Further, the shell comprises a first housing, a second end of the first housing is detachably connected with a second housing, a second end of the second housing is detachably connected with an end cover, and waterproof parts are respectively arranged between the first housing and the second housing, as well as between the second housing and the end cover.

Further, a first end of the first housing is provided with a piercing part for breaking a food surface, and a diameter of the piercing part gradually decreases from the second end to the first end.

Further, a top end of the piercing part transitions through an arc surface.

Further, the second end of the first housing is provided with a first connecting part, a first end of the second housing is provided with a second connecting part, the first connecting part and the second connecting part are connected in a rotating manner.

Further, the second end of the second housing is provided with a third connecting part, a first end of the end cover is provided with a fourth connecting part, the third connecting part and the fourth connecting part are connected in a rotating manner, a second end of the end cover is provided with a sinking groove, and the sinking groove is used for inserting a disassembly tool.

Further, the first circuit board is electrically connected with a battery, and a plurality of temperature sensors; and the plurality of temperature sensors are located in different positions in the shell.

Further, the temperature sensors comprise a first temperature sensor and a second temperature sensor, the first temperature sensor is located in the first housing, the second temperature sensor is located in the copper tube antenna, a wire connecting the first circuit board and the second temperature sensor is arranged between the first circuit board and the second temperature sensor, and the wire is located in the copper tube antenna.

Further, the first end of the copper tube antenna is connected with the first circuit board through a screw.

Further, the fall resisting component comprises a first elastic member arranged on upper and lower sides of the temperature measuring component.

Further, the fall resisting component comprises a second elastic member; a first end of the second elastic member is abutted against a first end inside the shell, and a second end of the second elastic member is abutted against a first end of the temperature measuring component.

A Bluetooth food thermometer assembly, wherein the Bluetooth food thermometer assembly comprises the Bluetooth food thermometer as above, a charging bin for charging the Bluetooth food thermometer, and a terminal device communicating with the Bluetooth food thermometer and the charging bin.

Further, the charging bin comprises a bottom shell, the bottom shell is detachably connected with an upper cover, a power supply is arranged inside the bottom shell, a top of the bottom shell is provided with a storage tank for placing the Bluetooth food thermometer, pole sheets connected with a wire of the power supply are arranged inside the storage tank, and the pole sheets are electrically contacted with the Bluetooth food thermometer.

Further, a second circuit board electrically connected with the power supply and the pole sheets is arranged inside the bottom shell, and the second circuit board is further electrically connected with a Bluetooth microcontroller unit (MCU), a switch, a flexible printed circuit (FPC) antenna, indicator lights and a buzzer.

Further, the pole sheets comprise a positive pole sheet and negative pole sheets, the positive pole sheet is in contact with the end cover of the Bluetooth food thermometer, the negative pole sheets are in contact with the first housing of the Bluetooth food thermometer, and the negative pole sheets are located on both sides of the first housing for clamping the first housing.

Further, the indicator lights comprise a Bluetooth status indicator light, a power indicator light and a probe power indicator light; and the Bluetooth status indicator light is a red and green two-color light.

Further, the bottom shell comprises an upper shell and a lower shell, the upper shell and the lower shell are connected by a screw, and the lower shell is provided with a protective pad on a top of the screw.

Further, a magnet is arranged at each of four corners of a top of the lower shell.

Further, a bottom of the lower shell is provided with a power supply bin for placing the power supply, the lower shell is provided with a bin cover at the power supply bin, and the bin cover is detachable and clamped with the lower shell.

According to the above solutions, the present invention has the following beneficial effects:

1. In the present invention, the fall resisting component is arranged between the temperature measuring component and the shell, and the fall resisting component is located at the first end of, above and below the temperature measuring component, so that the food thermometer can protect the temperature measuring component from different directions when falling, and the safety of the food thermometer is improved during use; and, during assembly, the fall resisting component can position the temperature measuring component for easy assembly.

2. In the present invention, the copper tube antenna is adopted, a wire sleeve between the second temperature sensor and the first circuit board, as well as a charging wire between the shell and the first circuit board are eliminated, the number of accessories is reduced, and it is more environmentally friendly and low-carbon; and the simpler structure reduces the factors affecting the quality, reduces the defective rate, and improves the production efficiency and reliability.

### BRIEF DESCRIPTION OF THE DRAWINGS

In order to more clearly explain technical solutions in embodiments of the present invention, a simple introduction of accompany drawings which are needed to be used in the embodiments or description of the prior art is given in the following. It is obvious that the drawings described below are only some embodiments of the present invention, and for an ordinary person skilled in the art, other drawings can also be obtained from these drawings under the premise of no creative labor.

FIG. 1 is a three-dimensional structural schematic diagram of embodiment 1 of the present invention;

FIG. 2 is a structural explosion schematic diagram of embodiment 1 of the present invention;

FIG. 3 is a schematic diagram of an internal structure of embodiment 1 of the present invention;

FIG. 4 is a structural schematic diagram of a first elastic member in embodiment 1 of the present invention;

FIG. 5 is a structural schematic diagram of embodiment 2 of the present invention;

FIG. 6 is a schematic diagram of a front explosion structure of a charging bin in embodiment 2 of the present invention; and

FIG. 7 is a schematic diagram of an underside explosion structure of the charging bin in embodiment 2 of the present invention.

All reference numbers in the figures are as follows: 100. Bluetooth food thermometer; 200. charging bin; 300. terminal device; 1. shell; 11. a first housing; 12. a second housing; 13. end cover; 14. waterproof part; 15. piercing part; 2. temperature measuring component; 21. battery; 22. copper tube antenna; 23. temperature sensor; 24. a first circuit board; 25. wire; 26. fastener; 3. fall resisting component; 31. a first elastic member; 32. a second elastic member; 33. connecting part; 34. elastic bending part; 4. bottom shell; 41. storage tank; 42. upper shell; 43. lower shell; 44. protective pad; 45. magnet; 46. power supply bin; 47. bin cover; 5. upper cover; 6. power supply; 7. a second circuit board; 71. pole sheets; 711. positive pole sheet; 712. negative pole sheet; 72. Bluetooth MCU; 73. switch; 74. FPC antenna; 75. indicator lights; 751. Bluetooth status indicator light; 752. power indicator light; 753. probe power indicator light; 76. buzzer.

### DETAILED DESCRIPTION OF THE INVENTION

In order to make the technical problem to be solved by the present invention, technical solutions and beneficial effects be clearer, the present invention is further explained in detail in combination with the drawings and embodiments. It should be understood that the specific embodiments described herein are only intended to explain the present invention and are not intended to define the present invention.

It should be noted that when a part is said to be “fixed” or “set” or “connected” to another part, it may be located directly or indirectly on said another part. Directions or positions indicated by the terms such as “up”, “down”, “left”, “right”, “front”, “back”, “vertical”, “horizontal”, “top”, “bottom”, “inside”, “outside” are based on the directions or positions shown in the drawings and are for ease of description only and shall not be construed as limitations of the technical solutions. Terms such as “first”, “second” are used for descriptive purposes only and are not to be understood as indicating or implying relative importance or as implicitly indicating a quantity of technical features. “A plurality of” means two or more unless otherwise expressly specified. “Several” means one or more unless otherwise expressly specified.

### Embodiment 1

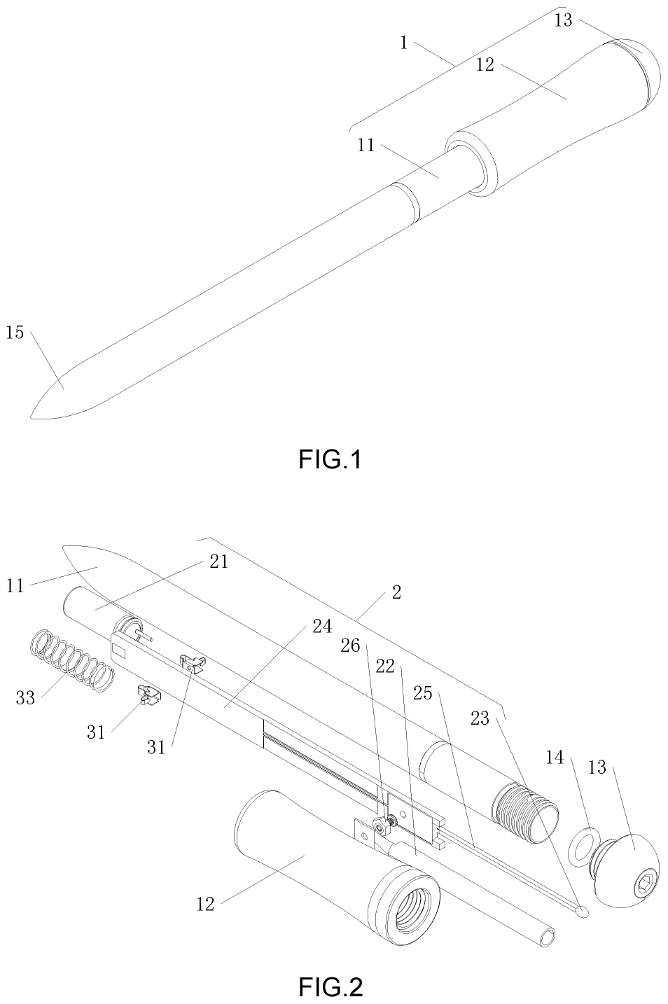

As shown in FIG. 1 to FIG. 3, provided is a Bluetooth food thermometer described in an embodiment of the present invention, wherein the Bluetooth food thermometer comprises a shell 1 in which a temperature measuring component 2 is movably arranged; a fall resisting component 3 is arranged between the temperature measuring component 2 and the shell 1; the fall resisting component 3 is used to protect the temperature measuring component 2 when falling; the temperature measuring component 2 comprises a copper tube antenna 22 and a first circuit board 24; a first end of the copper tube antenna 22 is connected with the first circuit board 24 through a fastener 26; and a second end of the copper tube antenna 22 is electrically contacted with the shell 1. The fastener 26 is adopted for connecting, which avoids that an external high temperature melts a solder joint through the copper tube antenna 22, so as to ensure the reliability of an electrical connection.

When used in this embodiment, part of the shell 1 is inserted into ingredients of which a temperature is needed to be measured, which can be used in cooking scenes such as frying, baking and cooking to detect an internal temperature of the ingredients and a temperature of an external environment of the ingredients. The temperature measuring component 2 can communicate, through Bluetooth, with an external terminal and can transmit data to a mobile phone, a tablet computer and other terminal devices, so as to monitor a heat condition of the ingredients during the cooking. Thus, it is easy to adjust the cooking temperature in real time to ensure the cooking effect.

In this embodiment, the fall resisting component 3 is arranged between the temperature measuring component 2 and the shell 1, so that the food thermometer has buffer of the fall resisting component 3 when it falls, and the temperature measuring component 2 moves in the shell 1 to reduce vibration, thereby protecting the temperature measuring component 2 and improving the safety of the food thermometer when it is used. The copper tube antenna 22 is adopted, a wire sleeve between the second temperature sensor and the first circuit board 24, as well as a charging wire between the shell 1 and the first circuit board 24 are eliminated, the number of accessories are reduced, and it is more environmentally friendly and low-carbon; and the simpler structure reduces the factors affecting the quality, reduces the defective rate, and improves the production efficiency and reliability.

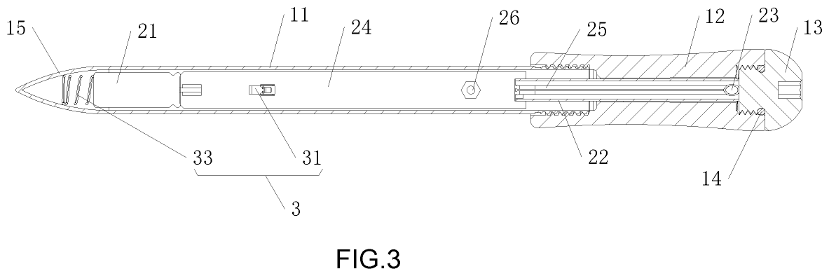

As shown in FIG. 2 and FIG. 3, in a preferred example, the shell 1 comprises a first housing 11, a second end of the first housing 11 is detachably connected with a second housing 12, a second end of the second housing 12 is detachably connected with an end cover 13, and waterproof parts 14 are respectively arranged between the first housing 11 and the second housing 12, as well as between the second housing 12 and the end cover 13. In FIG. 3, the left end is the first end and the right end is the second end.

A first end of the first housing 11 is provided with a piercing part 15 for breaking a food surface, and a diameter of the piercing part 15 gradually decreases from the second end to the first end. A top end of the piercing part 15 transitions through an arc surface, which is not easy to hurt a person.

The second end of the first housing 11 is provided with a first connecting part, a first end of the second housing 12 is provided with a second connecting part, the first connecting part and the second connecting part are connected in a rotating manner. The second end of the second housing 12 is provided with a third connecting part, a first end of the end cover 13 is provided with a fourth connecting part, the third connecting part and the fourth connecting part are connected in a rotating manner, a second end of the end cover 13 is provided with a sinking groove, and the sinking groove is used for inserting a disassembly tool.

In this embodiment, the first housing 11 is provided with the piercing part 15 at the first end, and the tip end of the piercing part 15 facilitates breaking of the surface of the ingredients, thus facilitating the insertion of the first housing 11 into the ingredients. The first housing 11 and the end cover 13 are made of stainless steel, which has good heat resistance and thermal conductivity, and can conduct the temperature to the temperature measuring component 2 to ensure the accuracy of temperature detection. The stainless steel has a good structural strength and is easy to pierce into the ingredients. The second housing 12 is made of high temperature resistant and insulating ceramic material. In general, when cooking, the temperature of the external environment of the ingredients is high. The ceramic material can withstand a higher environment temperature and has good insulation to protect the temperature measuring component 2.

In this embodiment, the first connecting part and the fourth connecting part are external threads, the second connecting part and the third connecting part are internal threads, that is, the second end of the first housing 11 is provided with the external threads, the first end of the second housing 12 is provided with the internal threads, the first housing 11 and the second housing 12 are connected with the threads; the second end of the second housing 12 is also provided with the internal threads, the first end of the end cover 13 is provided with the external threads, and the second housing 12 and the end cover 13 are connected with the threads. The sinking groove is a hexagonal groove, which can be used to have a hex wrench inserted for easy installation and detachment. Alternatively, the sinking groove is a groove of another shape such as a cross groove or a one-slot groove which is used with a corresponding disassembly tool. The waterproof part 14 comprises a glue layer filled at a threaded connection, and the waterproof part 14 also comprises a sealing gasket arranged at the threaded connection.

As shown in FIG. 2 and FIG. 3, in a preferred example, the temperature measuring component 2 comprises the first circuit board 24 which is electrically connected with a battery 21, the copper tube antenna 22 and a plurality of temperature sensors 23 which are located at different positions within the shell 1.

The temperature sensors 23 comprise a first temperature sensor and a second temperature sensor, the first temperature sensor is located in the first housing 11, the second temperature sensor is located in the copper tube antenna 22, a wire 25 connecting the first circuit board 24 and the second temperature sensor is arranged between the first circuit board and the second temperature sensor, and the wire 25 is located in the copper tube antenna 22.

The first end of the copper tube antenna 22 is connected with the first circuit board 24 through the fastener 26 such as a screw or a bolt.

In this embodiment, the first circuit board 24 is located in the first housing 11, and there is a Bluetooth chip with a microcontroller unit (MCU) on the first circuit board 24, where the first temperature sensor performs data interaction with the MCU through I2C, and the second temperature sensor obtains data of an external sensor by comparing a collected voltage with a voltage list stored inside. At the same time, the MCU also collects power of the battery 21 and compares it with a level of power of the battery 21 stored inside. If the power of the battery 21 is detected to reach the lowest level, a high power consumption part of the food thermometer needs to be closed or a frequency of use needs to be reduced. After collecting the above main data, it is sent to the charging bin and the external terminal through Bluetooth at a specified time interval.

The battery 21 is welded to a first end of the first circuit board 24, the battery 21 is a rechargeable battery, the battery 21 is cylindrical, an outer diameter of the battery 21 is equivalent to an inner diameter of the first housing 11, and a second end of the battery 21 is abutted against the first circuit board 24, the battery 21 itself has two long metal conductive wires welded to both sides of the first circuit board 24 so as to clamp the first circuit board 24. With the cylindrical battery 21, the first circuit board 24 may be centrally located inside the shell 1. The power of the battery 21 is divided into four levels, and the power of the battery 21 can be measured according to a set detection gap.

The second end of the first circuit board 24 is provided with a through hole, and the screw passes through the first end of the copper tube antenna 22 and is screwed into the through hole and is electrically connected with the first circuit board 24. The second end of the copper tube antenna 22 extends into the second housing 12 and is electrically contacted with the end cover 13. The copper tube antenna 22 can be used to enhance a signal and connect a charging positive pole of the power supply 6. The first temperature sensor and the second temperature sensor are thermistors (NTCs), the first temperature sensor is directly welded with the first circuit board 24, that is, the first temperature sensor is located in the first housing 11 and used to detect the temperature inside the ingredients, detection accuracy of the first temperature sensor can reach 1° C., a temperature detection range can reach −10° C.˜100° C.; the second temperature sensor is electrically connected with the first circuit board 24 through the wire 25, the second temperature sensor is located in the copper tube antenna 22 and used to detect the environment temperature outside the ingredients, that is, to detect the cooking temperature, detection accuracy of the second temperature sensor can reach 1° C., and a temperature detection range can reach −10° C.˜300° C. It is achieved that the temperature sensors of the food thermometer can achieve 1° C. accuracy through an NTC resistance segmenting control method, through different resistance values to achieve segmented detections of a low and medium temperature part and a high temperature part, so as to achieve 1° C. accuracy detection above 300° C. In addition, the second temperature sensor is arranged in the copper tube antenna 22, which can protect the second temperature sensor.

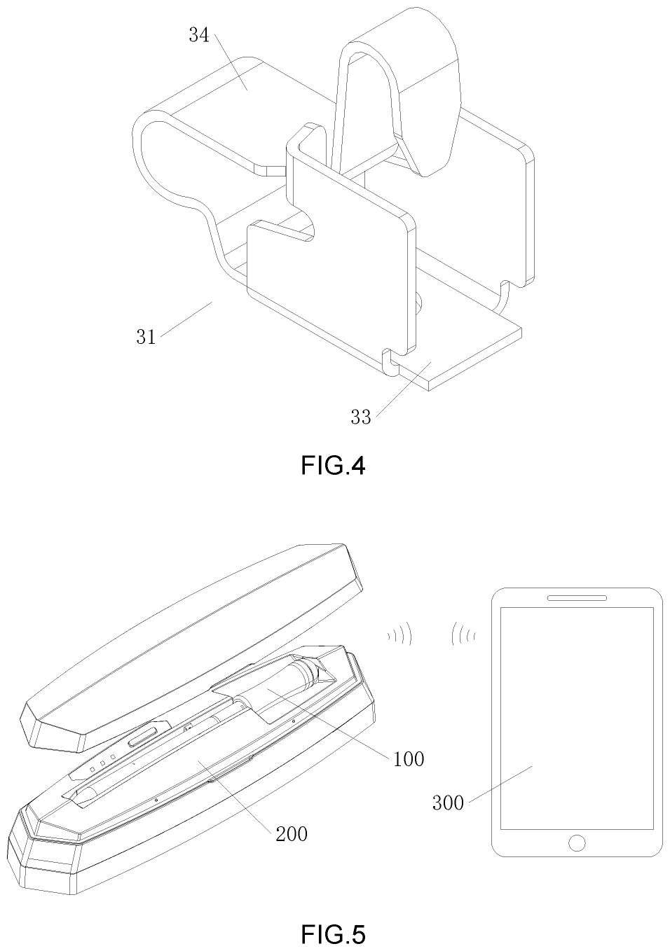

As shown in FIG. 2 to FIG. 4, in a preferred example, the fall resisting component 3 comprises a first elastic member 31 arranged on upper and lower sides of the temperature measuring component 2.

The fall resisting component 3 comprises a second elastic member 32, a first end of the second elastic member 32 is abutted against a first end inside the shell 1. In particular, the first end of the second elastic member 32 is abutted against the first end inside the first housing 11, a second end of the second elastic member 32 is abutted against a first end of the temperature measuring component 2. In particular, the second end of the second elastic member 32 is abutted against the first end of the battery 21.

In this embodiment, the first elastic member 31 is a metal shrapnel, and two metal shrapnels are welded respectively above and below the first circuit board 24 for limitation and drop buffering of upper and lower sides of the temperature measuring component 2. As the metal shrapnels abutted against an inner wall of the first housing 11, the first housing 11 is used as a charging negative pole connected to the power supply 6. Each metal shrapnel comprises a connecting part 33 welded with the first circuit board 24. A top of the connecting part 33 is connected with an elastic bending part 34, and a top of the elastic bending part 34 is abutted against the inner wall of the first housing 11 to facilitate positioning of the upper and lower sides of the temperature measuring component 2 for convenient assembly.

The second elastic member 32 is a spring, which is arranged at the first end of the temperature measuring component 2. A spring is used inside the tip of the first housing 11 to limit the first end of the temperature measuring component 2, so that the copper tube antenna 22 at the second end of the temperature measuring component 2 is in contact with the end cover 13. A second end of the spring is abutted against the first end of the battery 21, which can realize support of the battery 21 while realizing buffering protection effect of the battery 21 and an entire internal circuit when it falls. The copper tube antenna 22 is connected to the positive pole of the power supply 6 of the charging bin 200 by metal contact with the end cover 13.

### Embodiment 2

As shown in FIG. 5, provided is a Bluetooth food thermometer assembly in an embodiment of the present invention, wherein the Bluetooth food thermometer assembly comprises the Bluetooth food thermometer 100 as above, the charging bin 200 for charging the Bluetooth food thermometer 100, and a terminal device 300 communicating with the Bluetooth food thermometer 100 and the charging bin 200. In this embodiment, the terminal device 300 is a smart phone, tablet computer, etc., and a corresponding application program is installed on the terminal device 300, which can obtain the temperature of a cooking device and the internal temperature of the food at moment through a wireless data transmission manner such as Bluetooth, and make a cooking suggestion according to a setting of a preset recipe, such as cooking time, cooking temperature, and maturity reminder. By providing a time parameter in a way of timing, the accuracy of time can be guaranteed, the circuits of the Bluetooth food thermometer 100 and the charging bin 200 can be simplified, and low power consumption can be achieved at the same time. The application program combines the cooking suggestion and provide a user with a preferred menu recommendation.

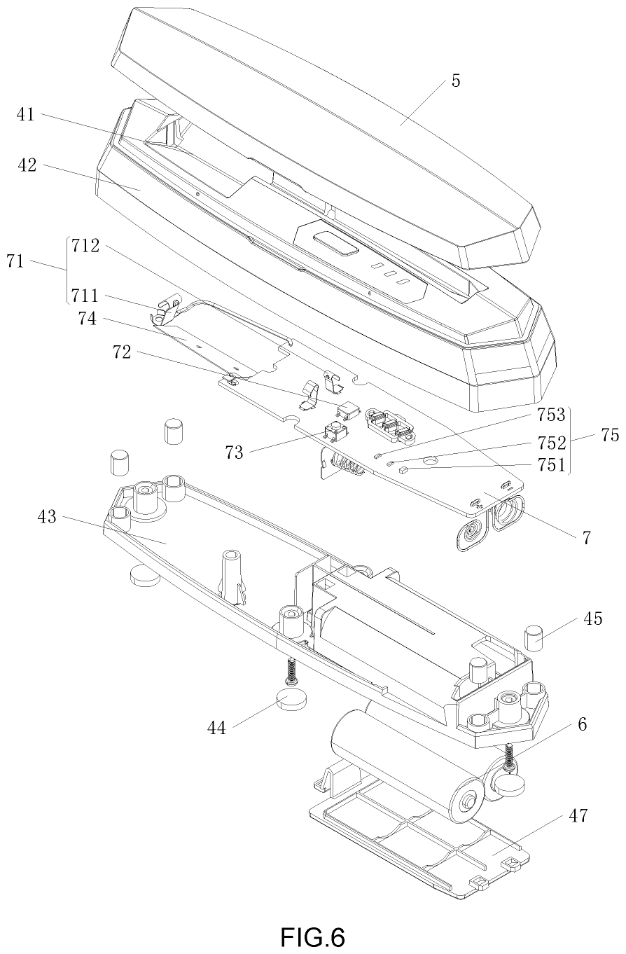

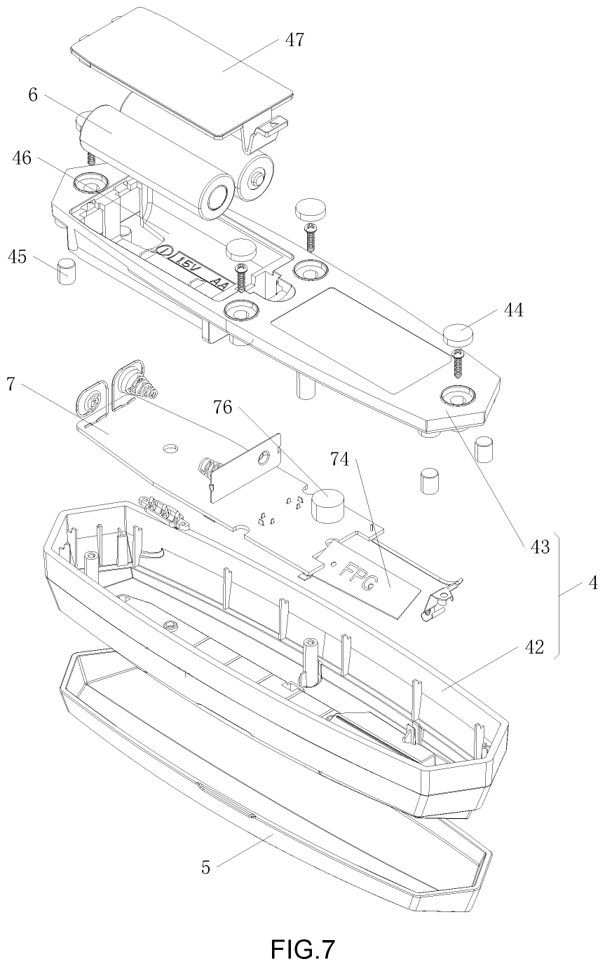

As shown in FIG. 6 and FIG. 7, in a preferred example, the charging bin 200 comprises the bottom shell 4, the bottom shell 4 is detachably connected with an upper cover 5, the power supply 6 is arranged inside the bottom shell 4, a top of the bottom shell 4 is provided with a storage tank 41 for placing the Bluetooth food thermometer 100, a pole sheet 71 connected with a wire of the power supply 6 is arranged inside the storage tank 41, and the pole sheets 71 are electrically contacted with the Bluetooth food thermometer 100.

The pole sheets 71 comprise a positive pole sheet 711 and negative pole sheets 712, and the positive pole sheet 711 is in contact with the end cover 13 of the Bluetooth food thermometer 100, the negative pole sheets 712 are in contact with the first housing 11 of the Bluetooth food thermometer 100, and the negative pole sheets 712 are located on both sides of the first housing 11 for clamping the first housing 11.

In this embodiment, the size of the storage tank 41 is equivalent to the external size of the Bluetooth food thermometer 100 to prevent putting upside down, and the storage tank 41 is provided with an opening at the second housing 12 to facilitate taking or placement of the Bluetooth food thermometer 100. After the Bluetooth food thermometer 100 is placed in the storage tank 41, the end cover 13 is abutted against the positive pole sheet 711, the positive pole sheet 711 is connected to the positive pole of the power supply 6, and used for positioning of the Bluetooth food thermometer 100 in an axial direction. The negative pole sheets 712 are in contact with the two sides of the first housing 11, one negative pole sheet 712 is used to connect the negative pole of the power supply 6, the other negative pole sheet 712 is used for insertion detection or removal detection of the Bluetooth food thermometer 100, and a charging current is collected to control a charging process, and the two negative pole sheets 712 realize radial positioning of the Bluetooth food thermometer 100.

As shown in FIG. 6 and FIG. 7, in a preferred example, a second circuit board 7 electrically connected with the power supply 6 and the pole sheets 71 is arranged inside the bottom shell 4, and the second circuit board 7 is further electrically connected with a Bluetooth MCU 72, a switch 73, a flexible printed circuit (FPC) antenna 74, indicator lights 75 and a buzzer 76, and the second circuit board 7 is connected to FPC antenna 74 through the shrapnel. The switch 73 is used to set Bluetooth communication pairing and reconnection of the Bluetooth food thermometer 100 and charging bin 200, and by shortly pressing the switch 73, it can also realize cancellation of alarm. The indicator lights 75 comprise a Bluetooth status indicator light 751, a power indicator light 752, and a probe power indicator light 753. The Bluetooth status indicator light 751 is a red and green two-color light, which reflects Bluetooth communication status between the Bluetooth food thermometer 100 and the charging bin 200, and can indicate the status of connection, disconnection, pairing, etc. The power indicator light 752 indicates status of a voltage of the power supply 6 in the charging bin 200. The probe power indicator light 753 can display three states of low power, charging, and charging saturation of the Bluetooth food thermometer 100 through a flashing frequency. The buzzer 76 is used for an alarm mechanism, mainly to realize a temperature reminder and a reminder of turning over time.

As shown in FIG. 6 and FIG. 7, in a preferred example, the bottom shell 4 comprises an upper shell 42 and a lower shell 43, the upper shell 42 and the lower shell 43 are connected by a screw, the lower shell 43 is provided with a protective pad 44 on a top of the screw, and a magnet 45 is arranged at each of four corners of a top of the lower shell 43. A bottom of the lower shell 43 is provided with a power supply bin 46 for placing the power supply 6, the lower shell 43 is provided with a bin cover 47 at the power supply bin 46, and the bin cover 47 is detachable and clamped with the lower shell 43.

In this embodiment, by setting the protective pad 44, the screw can be protected on one hand, and the bottom shell 4 can be supported on the other hand, so that the bottom shell 4 can be placed smoothly on a table surface, and the bottom shell 4 can be adsorbed on the ferromagnetic table surface by setting the magnets 45 to further improve the placement stability. The power supply 6 can be easily replaced by setting the power supply bin 46 and the bin cover 47.

The above are only preferred embodiments of the present invention, and are not used to limit the present invention, and any modification, equivalent replacement and improvement made within the spirit and principle of the present invention shall be included in the protection scope of the present invention.

What is claimed is:

1. A Bluetooth food thermometer, wherein the Bluetooth food thermometer comprises a shell in which a temperature measuring component is movably arranged; a fall resisting component is arranged between the temperature measuring component and the shell; the fall resisting component is used to protect the temperature measuring component when falling; the temperature measuring component comprises a copper tube antenna and a first circuit board; a first end of the copper tube antenna is connected with the first circuit board through a fastener; and a second end of the copper tube antenna is electrically contacted with the shell.

2. The Bluetooth food thermometer according to claim 1, wherein the shell comprises a first housing, a second end of the first housing is detachably connected with a second housing, a second end of the second housing is detachably connected with an end cover, and waterproof parts are respectively arranged between the first housing and the second housing, as well as between the second housing and the end cover.

3. The Bluetooth food thermometer according to claim 2, wherein the second end of the first housing is provided with a first connecting part, a first end of the second housing is provided with a second connecting part, the first connecting part and the second connecting part are connected in a rotating manner; and
the second end of the second housing is provided with a third connecting part, a first end of the end cover is provided with a fourth connecting part, the third connecting part and the fourth connecting part are connected in a rotating manner, a second end of the end cover is provided with a sinking groove, and the sinking groove is used for inserting a disassembly tool.

4. The Bluetooth food thermometer according to claim 1, wherein the first circuit board is electrically connected with a battery, and a plurality of temperature sensors; and the plurality of temperature sensors are located in different positions in the shell.

5. The Bluetooth food thermometer according to claim 4, wherein one of the temperature sensors is located in the copper tube antenna.

6. The Bluetooth food thermometer according to claim 1, wherein the fall resisting component comprises a first elastic member arranged on upper and lower sides of the temperature measuring component.

7. The Bluetooth food thermometer according to claim 1, wherein the fall resisting component further comprises a second elastic member; a first end of the second elastic member is abutted against a first end inside the shell, and a second end of the second elastic member is abutted against a first end of the temperature measuring component.

8. A Bluetooth food thermometer assembly, wherein the Bluetooth food thermometer assembly comprises the Bluetooth food thermometer according to claim 1, a charging bin for charging the Bluetooth food thermometer, and a terminal device communicating with the Bluetooth food thermometer and the charging bin.

9. The Bluetooth food thermometer assembly according to claim 8, wherein the charging bin comprises a bottom shell, the bottom shell is detachably connected with an upper cover, a power supply is arranged inside the bottom shell, a top of the bottom shell is provided with a storage tank for placing the Bluetooth food thermometer, pole sheets connected with a wire of the power supply are arranged inside the storage tank, and the pole sheets are electrically contacted with the Bluetooth food thermometer.

10. The Bluetooth food thermometer assembly according to claim 9, wherein a second circuit board electrically connected with the power supply and the pole sheets is arranged inside the bottom shell, and the second circuit board is further electrically connected with a Bluetooth microcontroller unit (MCU), a switch, a flexible printed circuit (FPC) antenna, indicator lights and a buzzer.
